(19) United States
(12) Patent Application Publication
(10) Pub. No.: US 2002/0120514 A1
(43) Pub. Date: Aug. 29, 2002

(54) Method, computer system and computer program product for processing customer loyalty data

(75) Inventors: Joachim Hagmeier, Stuttgart (DE); Jutta Kreyss, Styttgart (DE); Mark Bassam Salem, Park City, UT (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY

(21) Appl. No.: 10/068,369

(22) Filed: Feb. 6, 2002

(30) Foreign Application Priority Data
Feb. 6, 2001 (EP) 01102562.4

(51) Int. Cl. G06F 17/60

(52) U.S. Cl. 705/14

(57) ABSTRACT

A marketing computer, a front-end computer, a back-end computer and a point-of-sale terminal are interconnected by networks. After loyalty rules for a customer loyalty program are entered and tested in the marketing computer, the corresponding loyalty rules are updated in the front-end computer. The front-end computer can be a relatively inexpensive device as it does not require a graphical user interface.

### FIELD OF THE INVENTION

The present invention relates generally to data processing of customer loyalty data and, more particularly, to a distributed computer system having a point-of-sale terminal at the front-end for capturing customer data.

### BACKGROUND OF THE INVENTION

So called customer loyalty systems play an increasingly important role in all areas of marketing and business, such as the sale of goods and services to end consumers. Examples include customer loyalty systems of airlines, such as the “miles and more” program of Lufthansa. Other bonus systems exist for virtually any kind of goods and services. Such bonus systems typically provide rebates or gifts to customers once a certain threshold of bonus points has been surpassed. For a comprehensive review of customer loyalty systems refer to: Butscher, S. A. (1998): Customer Clubs and Loyalty, Programmers: A practical guide. Gower; Datamonitor (1998): Customer Loyalty Technologies in European Retail. A Marketing Study.

From U.S. Pat. No. 6,119,933 a method for customer loyalty and marketing analysis is known. The customer frequency, analysis and reward system has multiple alternative components and allows for input of customer identification through use of a smart card, biometric input device, or a preexisting identification, such as a credit card, government-issued id, or checking account. A customer interacts with the system initially at a data collection point-of-sale (POS) device at a retail outlet. Data is periodically collected from the retail site to a data warehouse, where various types of analysis may be performed. A customer can interact with the system using an internet interface.

U.S. Pat. No. 6,129,274 shows a system for updating shopping transaction history data using an electronic personal digital shopping assistant. This includes an electronic personal shopping system for communicating between a customer's personal memory store and point-of-sale terminals in a retail facility. Demographic profile data, a customer's transaction history data and a customer's current incentive indicia are stored in particular locations in a memory of a portable, machine-readable smart card. The smart card is adapted to interface with a store's check-out terminals and customer assistance, or kiosk terminals. Check-out terminals record a customer's most recent transactions in the customer's transaction history storage area and update a customer's current incentive indicia to reflect the most recent purchase.

From U.S. Pat. No. 6,000,608 a loyalty card is known having an identification number comprising a bank identification number which assists in establishing communications links. The card system can be accessed from any existing point-of-sale (POS) device. The POS device treats the card as a credit or debit card and routes transaction data to a processing hub using the banking system. The processing hub coordinates the various databases corresponding to the various functions of the card

U.S. Pat. No. 6,009,415 shows a data processing technique for scoring bank customer relationships and awarding incentive rewards. Such relationships may include deposit accounts, loan accounts, and customer referrals. Customer data describing the relationship between the bank and its customers is furnished by the customers and extracted from a bank customer information file. Incentive rewards, such as reduced loan rates or increased deposit account interest, are awarded to customers based on the relationship scores. Management reports summarize the relationships between the bank and its customers and provide marketing information.

Further loyalty and incentive award programs using data processing and card systems are known from U.S. Pat. Nos. 6,026,370 and 5,025,372.

The present invention solves the problems associated with prior art data processing systems for processing of customer loyalty data by providing an improved computer system, front-end computer device, point-of-sale terminal, computer program product and method for implementation of a customer loyalty system. In brief the invention provides for front-end devices, such as front-end input terminals for inputting of transaction data, such as data specifying goods or services to be purchased by a customer. The front-end devices can be distributed in the field, for example in retail shops, super market and point-of-sale terminals. The front-end devices have a spreadsheet engine which comprises the data processing kernel of a spreadsheet program such as Lotus 1-2-3 or Microsoft Excel.

The invention is particularly beneficial in that it allows use of a front-end device without a graphical user interface. This way the front-end device only requires minimal resources and can thus be implemented in an inexpensive way.

The front-end device has a database for storing of loyalty rules for access by its spreadsheet engine. Further the front-end device has a memory for storing of user data. When transaction data are inputted into the front-end device, the front-end device connects to a backend computer for synchronization. The synchronization can be done via a telephone line, a wireless communication path, the internet or an intranet. An appropriate schedule for a synchronization can be one a day.

The front-end device advantageously can be integrated with a point-of-sale terminal for a processing of a customer's checkout and payment. Furthermore the invention is advantageous in that it allows the updating of loyalty rules without a need to separately reprogram each of the front-end devices in the field. Changing of loyalty rules in the database of the back-end computer will cause updating of the loyalty rules of the front-end devices when a synchronization occurs.

It is a further advantage that the loyalty rules can be edited on a marketing computer using a graphical user interface. Testing can be performed on the marketing computer by usage of test user and test terminal data. After successful testing of a modified loyalty rule on the marketing computer the modified rule or the modified set of rules can be transfered to the loyalty rule database of the back-end computer. From there the modified loyalty rules are further distributed to the front-end devices on the occasion of a synchronization.

### BRIEF DESCRIPTION OF THE DRAWINGS

The present invention together with the above and other objects and advantages may best be understood from the following detailed description of the preferred embodiment of the invention illustrated in the drawings, in which:

FIG. 1-FIG. 5 show examples of a spreadsheet engine with loyalty rules using a graphical user interface;

FIG. 6 shows a schematic block diagram of a computer system for processing of loyalty rules;

FIG. 7 shows a more detailed view of the point-of-sale terminal computer of the embodiment shown in FIG. 6; and

FIG. 8 shows an embodiment of a method for performing a transaction in accordance with the invention.

### DETAILED DESCRIPTION

FIG. 1 illustrates by way of example the contents of test user data specifying a user profile. The test user profile is to be entered into column A of the spreadsheet. In the example considered here the spreadsheet program used is Lotus 1-2-3. However, any other spreadsheet program such as Microsoft Excel can also be utilized

Column B of the spreadsheet shown in FIG. 1 holds a data record specifying test terminal data. Column C of the spreadsheet is used for storage of bonus points or rewards obtained by a corresponding user.

The spreadsheet is displayed in a graphical user interface such as Microsoft Windows for convenient display and modification of data entries.

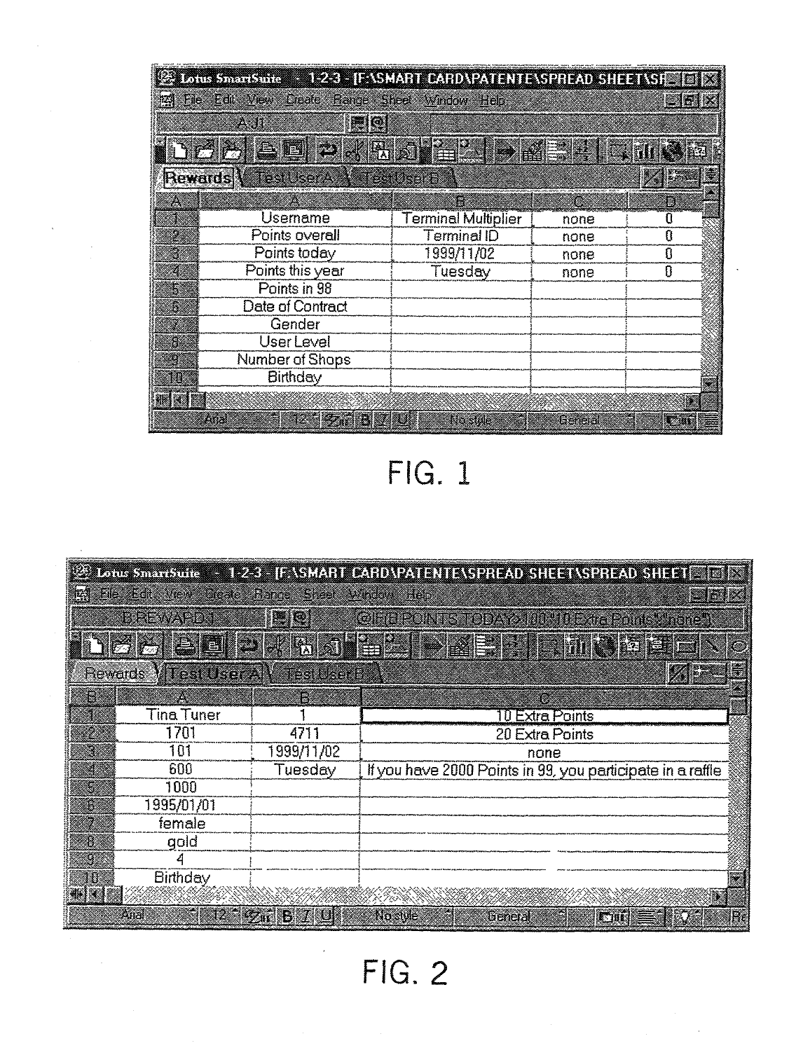

FIG. 2 shows an instance of a test user, corresponding test user data and test terminal data in the columns A, C and B, respectively. In the example considered here a customer obtains ten additional bonus points in the customer loyalty program if he or she purchases goods exceeding the amount of one hundred US dollars in a single day.

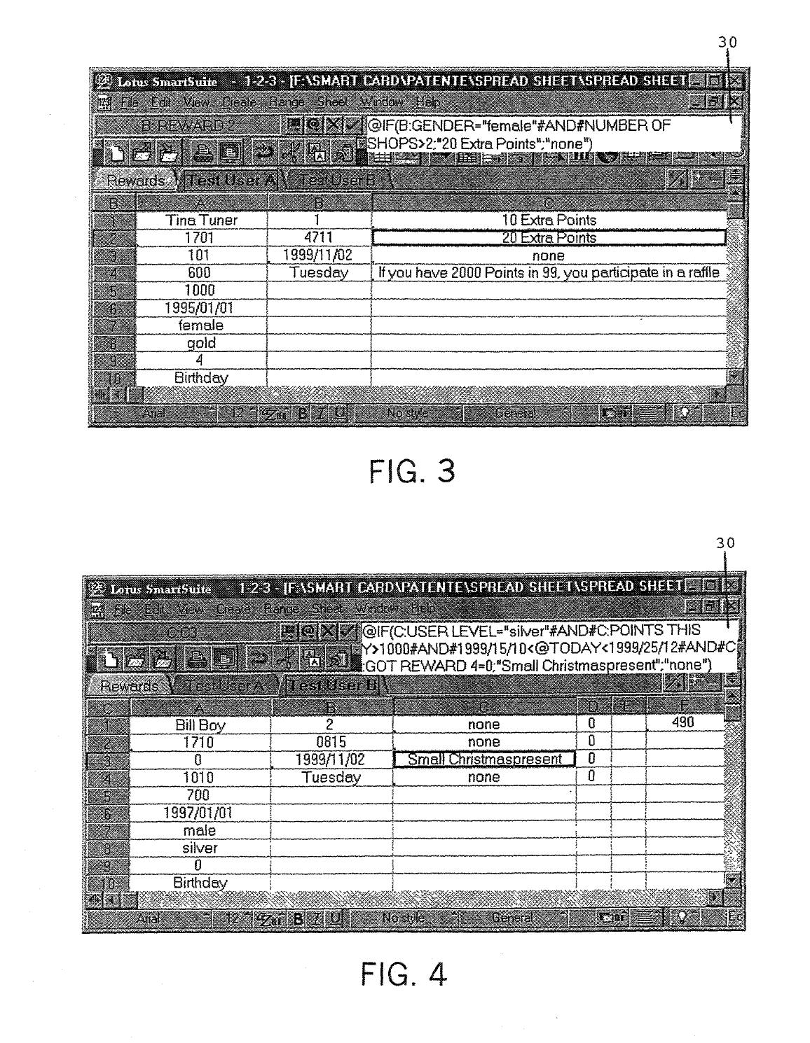

In accordance with the example of FIG. 3 another loyalty rule of the loyalty system is as follows: “If a female customer buys goods in more than two different shops of a shopping mall, she obtains twenty additional bonus points in the loyalty program of the shopping mall”. The corresponding loyalty rule is displayed in the field 30 of the spreadsheet.

It is also possible to modify a loyalty rule by entering a modification in the window 30 or by replacing the rule by a new one. Also additional rules can be entered into the window 30 and can thus be added to the set of loyalty rules of the customer loyalty program.

FIG. 4 shows a further example for a loyalty rule: “If a customer has obtained “silver-status” in the loyalty program of the shopping mall and if he or she shops in the time interval between October 15 and December 25, then he or she obtains a small Christmas present. Silver-status is obtained, if a customer has acquired more than one thousand bonus points in the preceding year. Again the corresponding loyalty rule is displayed in the window 30 and can be updated, modified or deleted.

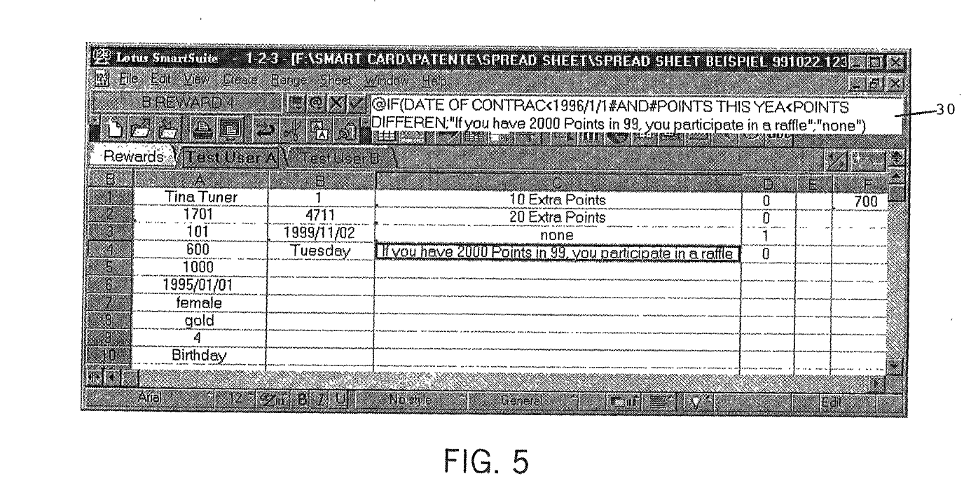

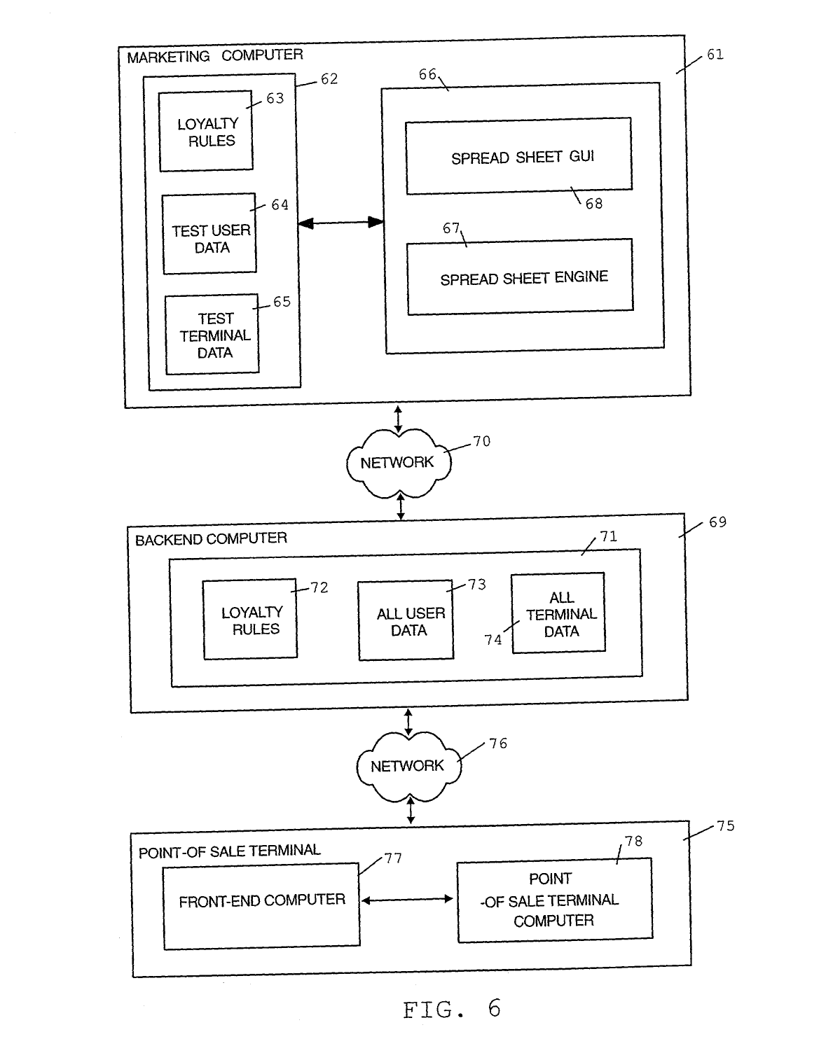

FIG. 5 shows a further example of a loyalty rule: “If the customer participates in the loyalty program of the shopping mall after Jan. 1, 1996 and if the number of loyalty bonus points acquired in the year 1999 is 30% below the bonus points acquired in the year 1998, the customer is informed that he or she will participate in a raffle of a cruise in the Caribbean provided that he or she obtains at least 2000 bonus points in the current year.” This rule is shown in the window 30.

For evaluating this rule a temporary field is used in the column F of the spreadsheet for storing an intermediate value.

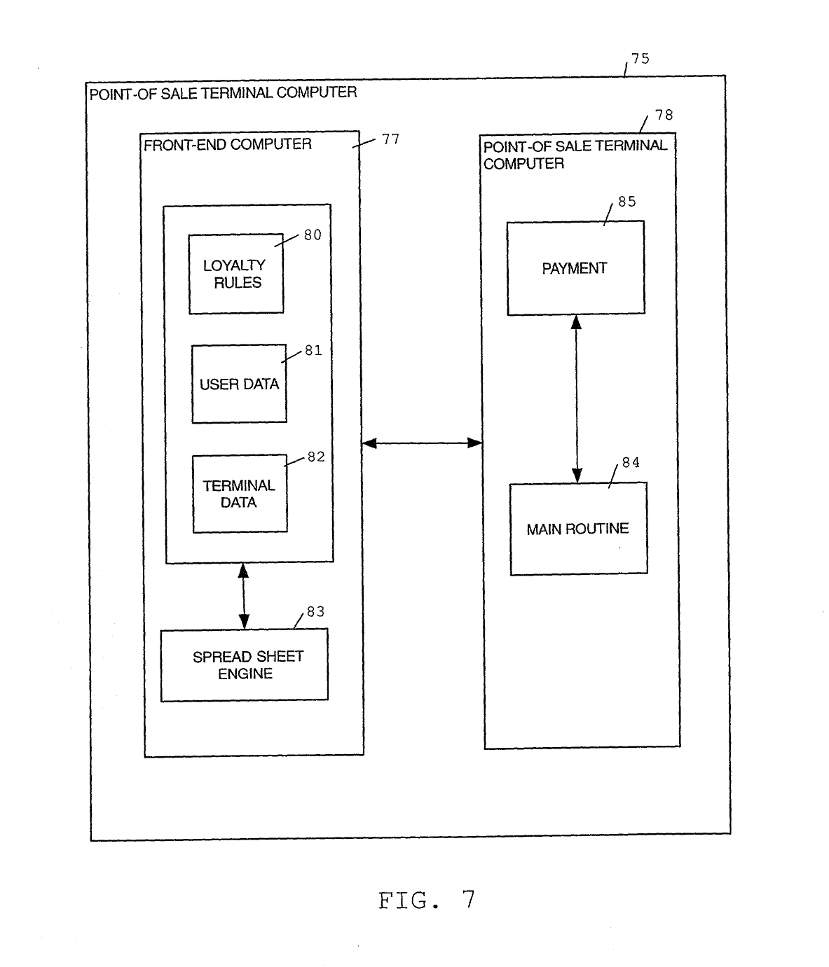

With reference to FIG. 6, an embodiment of the computer system of the invention is explained in more detail. The computer system has a marketing computer 61 having a database 62 for storage of loyalty rules 63, test user data 64 and test terminal data 65.

The loyalty rules 63 can be of the type as explained with reference with FIGS. 1 to 5. Likewise the test user data 64 can be of the type as shown in the columns A and C in the spreadsheets of FIGS. 1 to 5 describing a user's profile and history concerning the obtainment of bonus points, respectively. Likewise the test terminal data 65 can be of the type as shown in column B of the spreadsheets shown in FIGS. 1 to 5.

The database 62 interacts with a spreadsheet program 66. The spreadsheet program has spreadsheet engine 67 and a spreadsheet graphical user interface 68. The spreadsheet engine 67 can be a kernel of any standard spreadsheet program like Lotus 1-2-3 or Microsoft Excel. One way of realizing the spreadsheet graphical user interface 68 is by means of Microsoft Windows.

By means of the spreadsheet graphical user interface 68 it is possible to visualize, modify, delete, update and enter loyalty rules 63 in the database 62. Modified loyalty rules 63 can be tested in the marketing computer 61 for coherence with prior loyalty rules and simulation and testing with test user data 64 and test terminal 65.

The marketing computer 61 is coupled to back-end computer 69 via network 70. The back-end computer 69 has a database 71 for storage of loyalty rules 72, user data 73 and terminal data 74. The data contained in the database 71 is the set of data relied on for the real life operation of the computer system. The loyalty rules 72, user data 73 and terminal data 74 are the data which are actually used for the processing of real customer and transaction data. In particular the loyalty rules 72 are updated from time to time by transferring loyalty rules 63 from the marketing computer 61 to the back-end computer 69 via network 70 to the database 71 after the loyalty rules 63 have been tested successfully and are to be introduced into the market.

The back-end computer 69 is coupled to a point-of-sale terminal 75 via network 76. The point-of-sale terminal 75 has a front-end computer 77 and a point-of-sale terminal computer 78.

The front-end computer 77 captures user and transaction data which are provided by means of a manual input operation, a customer card, such as a smart card, or similar devices. The front-end computer 77 has a copy of the loyalty rules and terminal data relating to the point-of-sale terminal 75 to which it belongs. The front-end computer 77 is coupled to a point-of-sale terminal computer 78 for information exchange and control. In one embodiment an actual purchase price of a good which a customer desires to purchase is determined by the front-end computer 77 relying on the combination of loyalty rules and user data. The actual purchase price is provided by the front-end computer 77 to the point-of-sale terminal computer 78 for display of the actual price on a display of the point-of-sale terminal 75. The front-end computer 77 and point-of-sale terminal computer 78 can be integrated into the same physical unit or they can be realized by way of two separate devices.

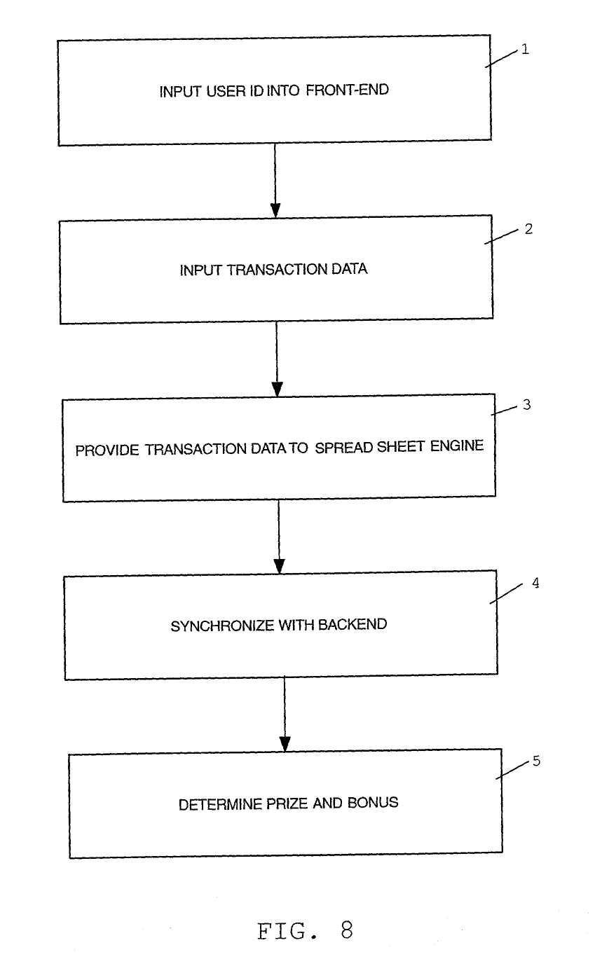

FIG. 7 shows an enlarged view of the point-of-sale terminal 75. The front-end computer 77 has a database 79 for storage of loyalty rules 80, user data 81 and terminal data 82. Further the front-end computer 77 has a spreadsheet engine 83 which can be a copy of the spreadsheet engine 67. In order to keep the front-end computer simple, a graphical user interface is not included such that front-end computer 77 only requires minimal data processing resources.

The point-of-sale terminal computer 78 has a main routine 84 and a payment module 85. The main routine 84 triggers the front-end computer 77 in case a purchase price is to be determined. After the determination of the purchase price based on the loyalty rule 80 and user data 81 the actual price is provided by the front-end computer 77 to the main routine 84 of the point-of-sale terminal computer 78 for processing in its payment module 85. The payment module 85 displays the actual price and carries out the transaction for receiving payment from the customer. The user data 81 is updated correspondingly if the customer receives bonus points for the purchase. The updated user data 81 is synchronized from time to time with the user data 73 of all users which is stored in the database 71 of the back-end computer 69.

On the occasion of a synchronization of the databases 79 and 71, the loyalty rules 80 in the front-end computer 77 are updated by loyalty rules 72 of the back-end computer 69.

FIG. 8 shows a flow chart illustrating an embodiment of the method of the invention. In step 1 a user ID is inputted into the front-end computer. This can be done manually or by means of a smart card or other authentication means.

In step 2 transaction specific data is inputted detailing the good or service a customer desires to purchase. This transaction data is provided to the spreadsheet engine in step 3 which accesses the user data of the user who desires to purchase the good or service, including the purchase history of the user, as well as the set of loyalty rules of the applicable customer loyalty program. As a result the spreadsheet engine updates the user data, for example by providing additional bonus points and storing the additional bonus points in the user profile.

In step 4 the front-end computer is synchronized which the back-end computer to transfer updated user data to the back-end and obtain updated loyalty rules from the back-end, if any.

In step 5 the actual price is determined and outputted based on the updated loyalty rules.

A particular advantage of the invention is that it supports the evaluation of an applicable loyalty rule 80 “on schedule” without a need of a further trigger. This feature can rely on the functionality of the spreadsheet engine 83.

Furthermore it can be beneficial to define temporary fields in the spreadsheet for a storage of intermediate results which are used more than once. For example in case that a rebate is provided to a customer if the customer has obtained more bonus points in the present year than in the last year, it saves processing time to determine the amount of bonus points obtained last year and to perform the comparison operation only once and to temporally save the corresponding data in a temporary field in the front-end computer until the current transaction has been completed.

What is claimed is:

1. A computer system comprising
a) a back-end computer having a first database for storing loyalty rules and user data;
b) a front-end computer having a second database for storing loyalty rules and for storing user data and a spreadsheet engine for processing user transaction data in accordance with the loyalty rules; and
c) a communication link connecting the back-end computer and the front-end computer for synchronization of the first and the second databases.

2. The computer system of claim 1 further comprising a point-of-sale terminal coupled to the front-end computer.

3. The computer system of claim 2 wherein the point-of-sale terminal includes a computer program routine for triggering operation of the spreadsheet engine and a payment application program.

4. The computer system of claim 2 or 3 wherein the point-of-sale terminal and the front-end computer are integrated into one device having a common display unit.

5. The computer system of claim 4 further comprising:
a) a marketing computer having a third database for receiving and storing loyalty rules and test user data, a second spreadsheet engine having a graphical user interface; and
b) a communication link connecting the marketing computer and the back-end computer for updating the loyalty rules stored in the first database.

6. A front-end computer device having a database for storing loyalty rules and user data and a spreadsheet engine for receiving and processing of transaction data of a user in accordance with the loyalty rules, the front-end computer device being adapted to be coupled with a back-end computer device via a communications link to synchronize its database with a corresponding database in the back-end computer device.

7. The front-end computer device of claim 6 further comprising a communication module.

8. A point-of-sale terminal comprising a front-end computer device as set forth in claim 6 or 7 and having a computer program routine for triggering operation of the spreadsheet engine and a payment application program.

9. A method for performing a transaction comprising the steps of:
a) inputting user-identifying data into a front-end computer device having a database for storing loyalty rules and user data and a spreadsheet engine for receiving and processing of transaction data;
b) inputting transaction data into the front-end computer device;
c) processing the transaction data in the spreadsheet engine in accordance with a loyalty rule; and
d) synchronizing the front-end computer device with a back-end computer.

10. The method for performing a transaction in accordance with claim 9 further comprising the steps of:
a) determining a price to be paid by a customer in accordance with the loyalty rule; and
b) displaying the price on the display of a point-of-sale terminal.
